(19) United States
(12) Patent Application Publication
(10) Pub. No.: US 2021/0209028 A1
(43) Pub. Date: Jul. 8, 2021

(54) CONTROLLING PROCESSOR INSTRUCTION EXECUTION

(71) Applicant: International Business Machines Corporation, Armonk, NY (US)

(72) Inventors: Wen Zhe Shi, Beijing (CN); Ai Ping Feng, Beijing (CN); Jing Wang, Beijing (CN); Shuo Zhang, Beijing (CN); Hong Yan Gu, Beijing (CN)

(21) Appl. No.: 16/735,923

(22) Filed: Jan. 7, 2020

(51) Int. Cl. G06F 12/0875; G06F 9/30

(52) U.S. Cl. CPC G06F 12/0875; G06F 9/30058; G06F 2212/1032; G06F 2212/452; G06F 9/30043

(57) ABSTRACT

Improving execution of application program instructions by sending a READ cache memory request for an address from a processor to a cache memory controller, receiving a cache miss result for the address in response to the READ request, sending a READ memory directly request for the same address and then receiving the address's contents.

### BACKGROUND

The disclosure relates generally to managing the execution of processor instructions. The disclosure relates particularly to reducing system vulnerabilities by managing processor instruction execution.

Computer processors operate by loading program instructions from memory and subsequently executing the loaded instructions. Instructions may be executed in program order, or they may be executed out of order to increase program execution efficiency by reducing waiting times. Many programs contain branched instructions where subsequent instruction execution is tied to the outcome of decision instructions.

### SUMMARY

Aspects of the invention disclose methods, systems and computer readable media associated with managing application execution. In one aspect, application instruction execution may include sending a READ cache memory request for an address from a processor to a cache memory controller, receiving a cache miss result for the address in response to the READ request, sending a READ memory directly request for the same address and then receiving the address contents.

### BRIEF DESCRIPTION OF THE DRAWINGS

FIG. 1 provides a schematic illustration of a system, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Computer systems may be subject to direct attacks wherein the attacker seeks to gain a level of control over the system as a user, to directly alter properties or extract information. Defenses against such attacks are well known and include physical security protocols as well as password-based security methods.

Indirect attacks occur when a malicious actor seeks to extract valuable information from a system by forcing program exceptions and then reading the information from the system memory. One such attack includes commands to read invalid cache memory addresses. Such commands can lead to desired information being written into accessible memory locations despite the invalid address.

Many processors perform speculative execution of instructions relating to branching instructions. A branching instruction is a decision point in the program where the next instructions executed depend upon the resolution of the decision. To increase operating efficiencies, systems can execute instructions along every possible path from the decision block before the decision has been resolved. In this manner, once the decision is resolved, many of the next set of program instructions have already been executed and the program simply proceeds along the selected path. Results and pending commands from speculatively executed instructions associated with the paths which are not selected, are discarded.

Speculative instruction execution can create opportunities for malicious actors to extract information. False commands can be inserted into the program stream. The false instructions can include if-then instructions which can lead to speculative execution of the ‘then’ portion of the instruction. Desired information can be written into accessible areas where it can be read by a malicious actor. As an example, a READ command directed toward an illegal cache memory address can be inserted as the object of an if-then instruction. Speculative execution of the READ instruction will generate an exception, a “cache miss” result, due to the illegal cache memory address. Due to the cache miss result, data from the illegal address will be written into the cache. This data may then be available from the cache even after the READ command is cancelled due to the resolution of the speculative branch in favor of another path. After the data is written to the cache it can be accessed using known cache inference attacks.

One way to address such an attack is to disable all speculative execution associated with branching instructions. Such a solution eliminates the attacks but at the cost of the operating efficiencies (e.g., CPU performance is significantly reduced) associated with speculative execution of branched instructions. What is needed is a method for preventing attacks based upon speculative execution of READ commands for invalid addresses without disabling speculative execution of branched instructions, thereby eliminating and/or reducing CPU performance caused by said disablement.

The disclosed embodiments address the vulnerabilities described above without the need to disable branch prediction and speculative code execution or to recompile code. Under the embodiments, execution of the illegal READ instruction will not lead to writing data to the cache where it can be accessed by a cache inference attack.

In the disclosed embodiments, a cache hit result produces no performance reduction as the result does not alter instruction execution sequences. A cache miss result, in normal execution, may cause a delay of several CPU cycles. The cache miss itself, with no intervention from the disclosed embodiments, will cause a delay of hundreds of cycles due to the need to access memory due to the miss, so the performance impact of the additional few cycles caused by the disclosures is negligible. For a cache miss result during speculative execution for a correctly predicted result, the disclosures may waste a dozen CPU cycles waiting for the resolution of the branch. The cache miss rate for correctly predicted results is very low so this impact is also very low. For a cache miss result for incorrectly predicted results, the READ instruction is cancelled, improving performance as no resources are used to read the memory.

In an embodiment, a computer implemented method for managing application execution includes defining a READ memory directly command. This command enables a processor to request memory address contents directly from the main memory without having the system check for the address in the cache. In this embodiment, the command may be issued in response to the receipt of a cache miss result after the submission of a READ cache memory request.

In embodiments of the invention, a system processor issues a READ cache memory command for an address. In these embodiments, the cache processes the READ command and sends a response to the system processor. The system processor receives either a cache hit, indicating that the memory address has been located with the requested information, or a cache miss result indicating that the requested memory address is not in the cache memory. In an embodiment, during normal—non-speculative—execution without branching instructions, the cache miss result is not an indication of an attack on the system. In this embodiment, after determining that the READ request was part of a non-speculative execution, the computer processor may respond to the cache miss result by issuing a READ memory directly command, to read the address directly from memory, bypassing the cache. After the READ memory directly command is executed, the memory will send, and the computer processor will receive, the requested information.

In an embodiment where the READ instruction is part of a branch routine that is speculatively executed, the receipt of a cache miss result from the cache, in response to the READ cache memory address command, is treated as being potentially malicious. Accordingly, in response to the receipt of the cache miss result, the computer processor delays the READ cache memory address command by waiting until the branch result is returned before issuing a READ memory directly command. In an embodiment, after the branched instruction has completed and selected a branch including the READ memory address command, the READ memory directly command will be issued, and the contents of the address will be returned. In an embodiment, when resolution of the branched instruction selects a branch without the READ command, the READ cache memory command will be cancelled by the processor.

In an embodiment, an exception log may be kept, tracking the circumstances under which a cache miss result is returned. Such a log can be utilized to evaluate attacks upon the system as well as to determine system efficiency impacts associated with implementing the disclosed methods. The cache miss exception log may include event details including the instructions being executed, the address requests and the address contents related to the triggered cache miss event. In an embodiment, the exceptions log details may be used to quarantine command sources and to alert a user regarding those sources.

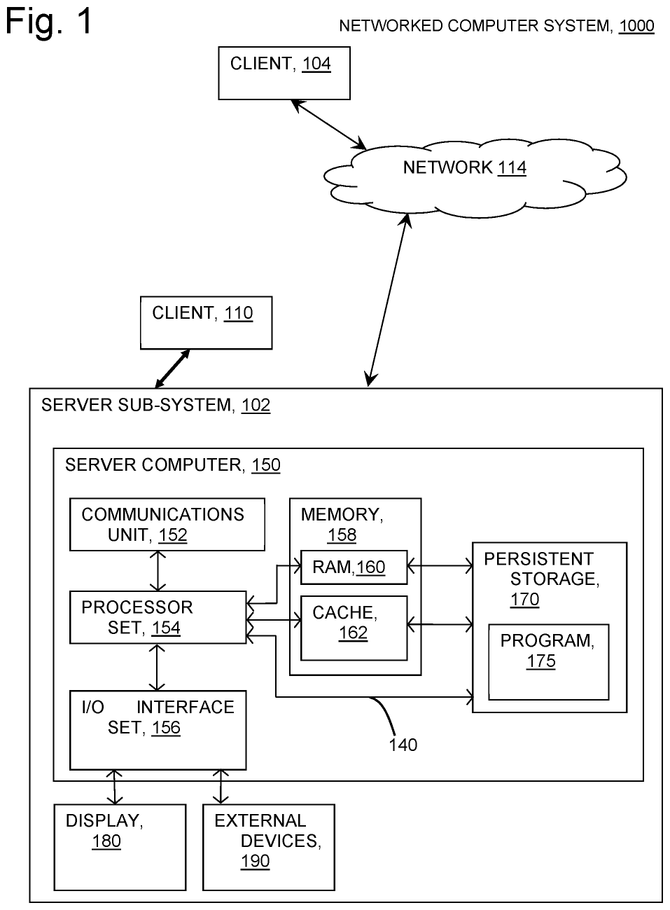

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise software programs (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, cache 162, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory 160 (RAM). In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the execution management program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., execution management program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

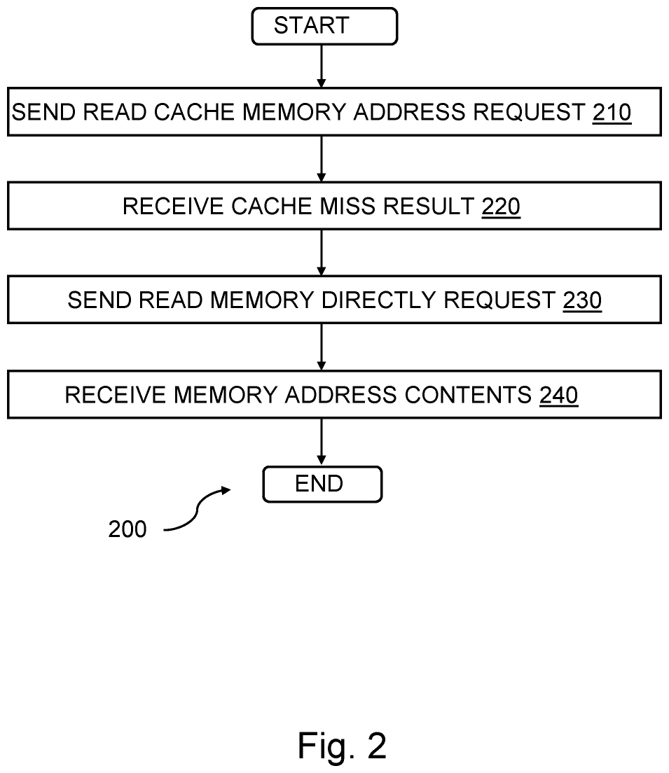

FIG. 2 provides a flowchart 200, illustrating exemplary activities associated with the practice of the disclosure. After program start, at 210, the processor sends a READ cache memory command for an address to the cache controller. The cache controller returns a result to the processor. A cache hit result indicates that the address was found in the cache. A cache miss result indicates that the address was illegal and was not found in the cache. The processor receives a cache miss result associated with the address at 220. At 230, the processor sends a READ memory directly request associated with the address commanding the memory controller to skip the cache search and to read the requested address directly from the main system memory. At 240, the processor receives the contents of the requested address in response to the READ memory directly command.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

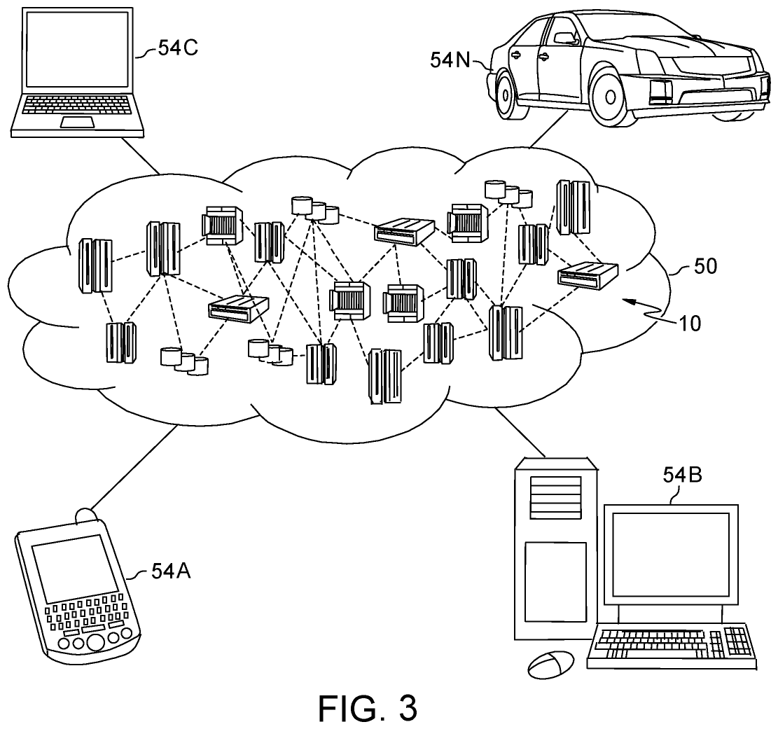

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

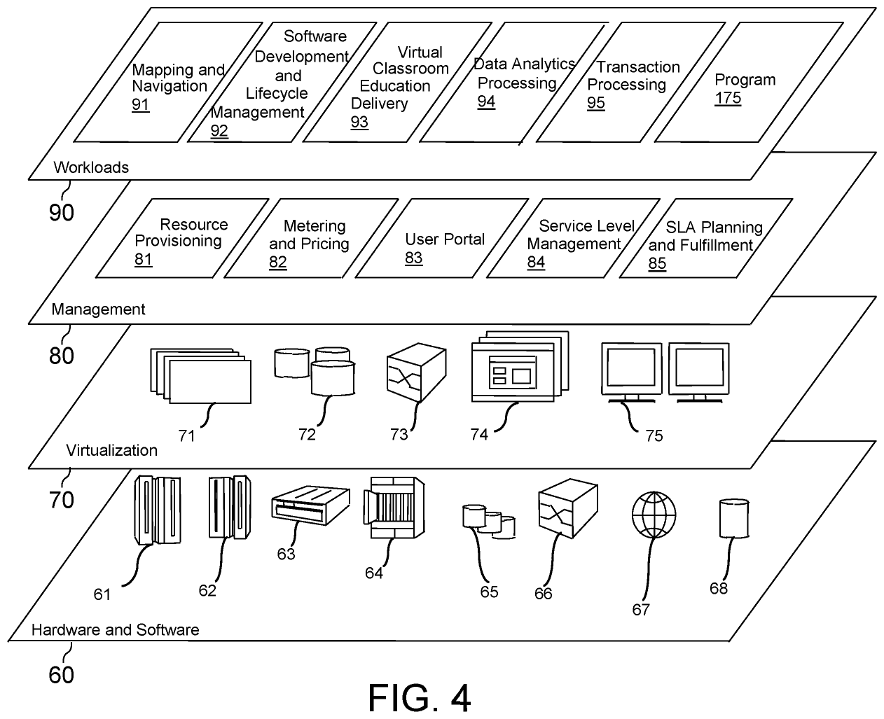

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and execution management program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for managing application execution, the method comprising:
sending, by one or more computer processors, a READ cache memory command for an address's content;
receiving, by the one or more computer processors, a cache miss result for the address;
sending, by the one or more computer processors, a READ memory directly command for the address; and
receiving, by the one or more computer processors, the address's content.

2. The computer implemented method according to claim 1, further comprising:
determining, by the one or more computer processors, in response to receiving the cache miss result, that the READ cache memory command is a normal command;
sending, by the one or more computer processors, the READ memory directly command for the address in response to determining that the READ cache memory command is a normal command; and
receiving, by the one or more computer processors, the address's content.

3. The computer implemented method according to claim 1, further comprising:
determining, by the one or more computer processors, in response to receiving the cache miss result, that the READ cache memory command is a speculative command; and
waiting, by the one or more computer processors, for completion of a branched instruction;
sending, by the one or more computer processors, the READ memory directly command for the address, subsequent to the branched instruction completion; and
receiving, by the one or more computer processors, the address's content.

4. The computer implemented method according to claim 1, further comprising:
storing, by the one or more computer processors, an address for which the cache miss result was returned.

5. The computer implemented method according to claim 1, further comprising:
receiving, by a cache memory portion of a computer processor, the READ cache memory command for an address;
sending, by the cache memory portion of a computer processor, the cache miss result;
receiving, by the cache memory portion of a computer processor, the READ memory directly command for the address; and
returning, by the cache memory portion of a computer processor, the address's content.

6. The computer implemented method according to claim 1, further comprising:
defining, by the one or more computer processors, the READ memory directly command.

7. The computer implemented method according to claim 1, further comprising:
generating, by the one or more computer processors, an exception log including details about the cache miss result.

8. A computer program product for managing application execution, the computer program product comprising one or more computer readable storage devices and stored program instructions on the one or more computer readable storage devices, the program instructions comprising:
program instructions for sending a READ cache memory command for an address's content;
program instructions for receiving a cache miss result for the address;
program instructions for sending a READ memory directly command for the address; and
program instructions for receiving the address's content.

9. The computer program product according to claim 8, the stored program instructions further comprising:
program instructions for determining, in response to receiving the cache miss result, that the READ cache memory command is a normal command;
program instructions for sending the READ memory directly command for the address in response to determining that the READ cache memory command is a normal command; and
program instructions for receiving the address's content.

10. The computer program product according to claim 8, the stored program instructions further comprising:
program instructions for determining in response to receiving the cache miss result, that the READ cache memory command is a speculative command; and
program instructions for waiting for completion of a branched instruction;
program instructions for sending the READ memory directly command for the address subsequent to the branched instruction completion; and
program instructions for receiving, by one or more computer processors, the address's content.

11. The computer program product according to claim 8, the stored program instructions further comprising:
program instructions for generating an exception log including details about the cache miss result.

12. The computer program product according to claim 8, the stored program instructions further comprising:
program instructions for receiving the READ cache memory command for an address;
program instructions for sending the cache miss result;
program instructions for receiving the READ memory directly command for the address; and
program instructions for returning the address's content.

13. The computer program product according to claim 8, the stored program instructions further comprising:
program instructions for storing an address for which the cache miss result was returned.

14. The computer program product according to claim 8, the stored program instructions further comprising:
program instructions for defining the READ memory directly command.

15. A computer system for managing application execution, the computer system comprising:
one or more computer processors;
one or more computer readable storage devices;
stored program instructions on the one or more computer readable storage devices for execution by the one or more computer processors, the stored program instructions comprising:
program instructions for sending a READ cache memory command for an address's content;
program instructions for receiving a cache miss result for the address;
program instructions for sending a READ memory directly command for the address; and
program instructions for receiving the address's content.

16. The computer system according to claim 15, the stored program instructions further comprising:
program instructions for determining, in response to receiving the cache miss result, that the READ cache memory command is a normal command;
program instructions for sending the READ memory directly command for the address in response to determining that the READ cache memory command is a normal command; and
program instructions for receiving the address's content.

17. The computer system according to claim 15, the stored program instructions further comprising:
program instructions for determining, in response to receiving the cache miss result, that the READ cache memory command is a speculative command; and
program instructions for waiting for completion of a branched instruction;
program instructions for sending the READ memory directly command for the address subsequent to the branched instruction completion; and
program instructions for receiving, the address's content.

18. The computer system according to claim 15, the stored program instructions further comprising:
program instructions for receiving the READ cache memory command for an address;
program instructions for sending the cache miss result;
program instructions for receiving the READ memory directly command for the address; and
program instructions for returning the address's content.

19. The computer system according to claim 15, the stored program instructions further comprising:
program instructions for defining the READ memory directly, command.

20. The computer system according to claim 15, the stored program instructions further comprising:
program instructions for generating an exception log including details about the cache miss result.
